(19) United States
(12) Patent Application Publication
(10) Pub. No.: US 2008/0236219 A1
(43) Pub. Date: Oct. 2, 2008

(54) LOCK DEVICE OF CLOSURE FOR VEHICLE

(75) Inventors: Nobuo SAKATE, Hiroshima (JP); Shinji KADOSHIMA, Hiroshima (JP); Katsuhiro DEGUCHI, Hiroshima (JP); Tsukasa ITO, Hiroshima (JP); Hideaki FUJII, Hiroshima (JP); Takahiko SHIGYOU, Hiroshima (JP)

Correspondence Address: Studebaker & Brackett PC, 1890 Preston White Drive, Suite 105, Reston, VA, 20191, US

(73) Assignee: MAZDA MOTOR CORPORATION, Hiroshima (JP)

(21) Appl. No.: 12/021,433

(22) Filed: Jan. 29, 2008

(30) Foreign Application Priority Data
Mar. 26, 2007 (JP) 2007-078388

(51) Int. Cl. B60R 25/00

(52) U.S. Cl. 70/237

(57) ABSTRACT

There are provided a striker, a latch to engage with the striker, the latch including a restriction portion operative to restrict a movement of a closure in a direction of a rotational axis of the closure by contacting the striker, wherein a low-friction material having lubricant function is provided at a contact portion of at least one of the striker and the restriction portion. Accordingly, there can be provided a lock device of a closure for a vehicle equipped with the restriction portion at the latch that can improve responsiveness of deformation of a vehicle body properly.

### BACKGROUND OF THE INVENTION

The present invention relates to a lock device of a closure for a vehicle.

A vehicle body has an opening portion for ingress/egress of passengers and/or an opening portion for loading/unloading of baggage, which are configured to be closed or opened by a closure, such as a side door or a lift gate. Such closures are configured to be locked in a closed state with a latch (striker) and a striker (latch) that engage with each other. Either one of them is provided at one side portion of the closure that is opposite to a side where a rotational axis of the closure is disposed, and the other is provided at the vehicle body. Herein, the latch has a groove portion for the striker coming in, and the width of the groove portion is generally configured to be wider than the width of the striker. Accordingly, there may occur an improper shaking of the closure while the vehicle is traveling or the like. This shaking of the closure may occur in a direction of the rotational axis of the closure.

Japanese Patent Laid-Open Publication No. 2001-349118 or Japanese Utility Model Laid-Open Publication No. 6-32647, for example, disclose some countermeasures for preventing the above-described improper shaking, in which the latch has a restriction portion that restricts a movement of the striker by contacting the striker from both sides of the direction of the rotational axis of the closure. Thereby, prevention of the improper shaking of the closure in the direction of the rotational axis of the closure can be expected to some extent.

Inventors of the present invention, however, have found that the above-described restriction of the striker may have a concern described below from a vehicle-body perspective.

That is, a vehicle body of an actual vehicle is not a perfect rigid body, but it has some resiliency, so that there inevitably occurs some deformation of the vehicle body when outer forces act on the vehicle body during the vehicle traveling state. Accordingly, it may be rather important to provide a quick and smooth responsiveness of deformation of the vehicle body in order to keep the stability of the vehicle traveling. Herein, in a case where the closure of the vehicle is configured such that the movement of the striker can be restricted by the restriction portion very tightly as described above, the inevitable deformation of the vehicle body at the opening portion may bring up a stronger deformation force between the opening portion and the closure, so that an improperly-abrupt relative movement between them could be caused by this stronger deformation force. This improperly-abrupt relative movement would influence the stability of the traveling vehicle inappropriately.

### SUMMARY OF THE INVENTION

An object of the present invention is to provide a lock device of a closure for a vehicle equipped with a restriction portion at a latch that can improve responsiveness of deformation of a vehicle body properly.

According to a first aspect of the present invention, there is provided a lock device of a closure for a vehicle, comprising a striker, a latch to engage with the striker, the latch including a restriction portion operative to restrict a movement of a closure in a direction of a rotational axis of the closure by contacting the striker, wherein a low-friction material having lubricant function is provided at a contact portion of at least one of the striker and the restriction portion. Herein, the closure may include various types of closures, such as a side door that is provided at a passenger-ingress/egress opening portion of a vehicle side face, a lift gate that is provided at a baggage-loading/unloading opening portion of a vehicle rear face or, a trunk lid that is provided at a trunk opening portion.

According to the present invention, the coefficient of friction of contact portions of the striker and the restriction portion of the latch is made small. Thereby, the contact portions of the striker and the restriction portion are made properly slippery so as to smooth the relative movement between the closure and the vehicle body in a direction other than the direction of the rotational axis of the closure. As a result, the responsiveness of deformation of the vehicle body when the outer force acts on the vehicle body can be improved. Accordingly, the stability of the vehicle when traveling, for example, improves. In the present invention, the low-friction material may be provided not only at the contact portions of the both members but at surrounding portion of the contact portions or at an entire part of the member.

According to an embodiment of the present embodiment, the closure is a member that is provided so as to open and close a rear opening portion of the vehicle. Thereby, the effect of the present invention can be obtained effectively in a case where the closure opens and closes the rear opening portion that may cause the deformation of the vehicle body easily when the outer force acts on.

According to another embodiment of the present embodiment, the low-friction material is a coating film of resin that is provided on a surface of the striker. Thereby, the anticorrosive effect can be obtained in addition to the low-friction effect. Further, the coating is superior in productivity as a method for covering the surface of the member having a shape like the striker. Herein, various types of coating method, such as spraying, electro-deposition, immersion, may be applied.

According to another embodiment of the present embodiment, the coating film is comprised of at least one of resins of phenol, epoxy, polyamide, polyimide, polyamideimide, and tetrafluoroethylene. Thereby, the coating can be conducted easily. Herein, the best resin can be chosen depending on a specific structure of the latch structure (e.g., a contact load with the restriction portion).

According to another embodiment of the present embodiment, the coating film contains a lubricant material that is comprised of at least one of molybdenum bisulfide, tungsten bisulfide, graphite, boron nitride, tetrafluoroethylene, and silicone resin. Thereby, the coefficient of friction between the striker and the restriction portion is made much lower, so that the above-described effect can be further improved.

According to another embodiment of the present embodiment, the volume ratio of the lubricant material relative to the coating film is 1 through 50%. Thereby, the low-friction effect and the wear resistance of the coating film can be made compatible. A too-low volume ratio of the lubricant material may cause an insufficient low-friction effect. Meanwhile, the more that ratio increases, the more the low-friction effect improves. However, over 50% of the volume ratio, the improvement of the low-friction effect may not change substantially, but the wear resistance may decrease and become short instead.

According to another embodiment of the present embodiment, the thickness of the coating film is 1 through 300 μm. Thereby, the wear resistance and the economical efficiency of the coating film can be made compatible. A too-thin thickness of the coating film may cause an insufficient resistance because of a prompt wear. Meanwhile, the more the thickness increases, the more the resistance improves. However, over the thickness of 300 μm, the resistance may become excessive, which may not be economical.

According to another embodiment of the present embodiment, the thickness of the coating film is 3 through 100 μm. Thereby, the wear resistance and the economical efficiency of the coating film can be made compatible properly.

According to another embodiment of the present embodiment, a surface roughness of the coating film is less than Ra 5.0 μm. Herein, Ra means a calculation-average roughness according to JIS (Japanese Industrial Standards). Thereby, any scratching or the like of the restriction portion can be prevented. A too-rough surface may scratch another member improperly. Herein, the surface roughness can be adjusted by a later-applied treatment.

According to another embodiment of the present embodiment, a surface roughness of the coating film is less than Ra 2.5 μm. Thereby, any scratching or the like of the restriction portion can be prevented properly.

According to another embodiment of the present embodiment, the striker is made from steel, and an anticorrosive treatment is applied to a base of the coating film. Thereby, the proper anticorrosive effect can be obtained, thereby improving the corrosion resistance. Various types of anticorrosive treatments, such as zincification, transformation, metal-piece dispersion treatment into a silicon-based inorganic binder, may be applied.

According to another embodiment of the present embodiment, the low-friction material is comprised of at least one of nickel and chromium and a plating layer that contains a lubricant material that is comprised of at least one of molybdenum bisulfide, tungsten bisulfide, graphite, boron nitride, tetrafluoroethylene, and silicone resin. Thereby, the coefficient of friction with the contacting member can be made low. Further, the superior resistance can be expected more, compared to the rein coating film. The best low-friction material can be chosen depending on the specific structure of the latch structure (e.g., a contact load with the contacting member). Further, applying a nickel or chromium based plating to the entire surface of the striker can provide the anticorrosive effect in addition to the low-friction effect.

According to another embodiment of the present embodiment, the volume ratio of the lubricant material relative to the plating layer is 1 through 50%. Thereby, the low-friction effect and the wear resistance of the plating layer can be made compatible. A too-low volume ratio of the lubricant material may cause an insufficient low-friction effect. Meanwhile, the more the that ratio increases, the more the low-friction effect improves. However, over 50% of the volume ratio, the improvement of the low-friction effect may not change substantially, but the wear resistance may decrease and become short instead.

According to another embodiment of the present embodiment, the thickness of the plating layer is 0.1 through 200 μm. Thereby, the wear resistance and the economical efficiency of the plating layer can be made compatible. A too-thin thickness of the plating layer may cause an insufficient resistance because of a prompt wear. Meanwhile, the more the thickness increases, the more the resistance improves. However, over the thickness of 200 μm, the resistance may become excessive, which may not be economical.

According to another embodiment of the present embodiment, the thickness of the plating layer is 1 through 50 μm. Thereby, the wear resistance and the economical efficiency of the plating layer can be made compatible properly.

According to another embodiment of the present embodiment, a surface roughness of the plating layer is less than Ra 2.0 μm. Thereby, any scratching or the like of the restriction portion can be prevented. A too-rough surface may scratch another member improperly. Herein, the surface roughness can be adjusted by a later-applied treatment.

According to another embodiment of the present embodiment, a surface roughness of the plating layer is less than Ra 0.5 μm. Thereby, any scratching or the like of the restriction portion can be prevented properly.

According to another embodiment of the present embodiment, the low-friction material is provided by at least one of manners of deposition, thermal spraying, film adhesion, and tube-inserting. Herein, the best method can be chosen depending on the specific structure of the latch structure (e.g., the contact load with the contacting member).

According to another embodiment of the present embodiment, a lubricant material as the low-friction material is provided on a surface of a base material of the restriction portion of the latch. Thereby, the coefficient of friction between the striker and the restriction portion can be made low.

According to another embodiment of the present embodiment, a lubricant material as the low-friction material is contained in a base material of the restriction portion of the latch. Thereby, the coefficient of friction between the striker and the restriction portion can be made much lower.

According to another embodiment of the present embodiment, a base material of the restriction portion of the latch is made from polyacetal, and the low-friction material is comprised of at least one of silicone resin, molybdenum bisulfide, tungsten bisulfide, graphite, boron nitride, tetrafluoroethylene, and lubricating oil. Thereby, the mechanical properties and the proper low friction of the restriction portion can be provided.

According to a second aspect of the present invention, there is provided a lock device of a closure for a vehicle, comprising a striker, a latch to engage with the striker, the latch including a restriction portion operative to restrict the striker, and a friction-lowering means for reducing the coefficient of friction between the striker and the restriction portion of the latch less than 0.1. Thereby, the both members can be made slippery in a direction that is other than a restriction direction by the friction-lowering means. Accordingly, like the above-described first aspect of the present invention, the responsiveness of deformation of the vehicle body can be improved and the stability of the vehicle can improve. Herein, the coefficient of friction of 0.1 is less than values of the friction coefficient of the zincification, chromium plating, or nickel plating.

According to a third aspect of the present invention, there is provided a lock device of a closure for a vehicle, comprising a striker, a latch to engage with the striker, the latch including a restriction portion operative to restrict a movement of a closure in a direction of a rotational axis of the closure by contacting the striker, and a smoothing means for smoothing a movement of the striker in a direction other than the direction of the rotational axis of the closure. Thereby, the both members can be made slippery in the direction that is other than the restriction direction by the friction-lowering means. Accordingly, like the above-described first aspect of the present invention, the responsiveness of deformation of the vehicle body can be improved and the stability of the vehicle can improve.

Other features, aspects, and advantages of the present invention will become apparent from the following description which refers to the accompanying drawings.

### BRIEF DESCRIPTION OF THE DRAWINGS

FIG. 1 is a side view of a vehicle rear portion to which a lock device of a closure for a vehicle according to an embodiment of the present invention is applied.

FIG. 2 is an enlarged side view of the lock device (a sectional view taken along line B-B of FIG. 3).

FIG. 3 is a sectional view taken along line A-A of FIG. 2.

FIG. 4 is an explanatory diagram of a testing method of the coefficient of friction.

FIG. 5 is a chart of test results of the coefficient of friction using a ball test piece and a disk test piece.

FIG. 6 is a chart of correlation of the content of tetrafluoroethylene and the coefficient of friction.

FIG. 7 is a sectional view of another lock device, which corresponds to FIG. 3.

### DETAILED DESCRIPTION OF THE INVENTION

Hereinafter, a lock device of a closure for a vehicle according to preferred embodiments of the present invention will be described.

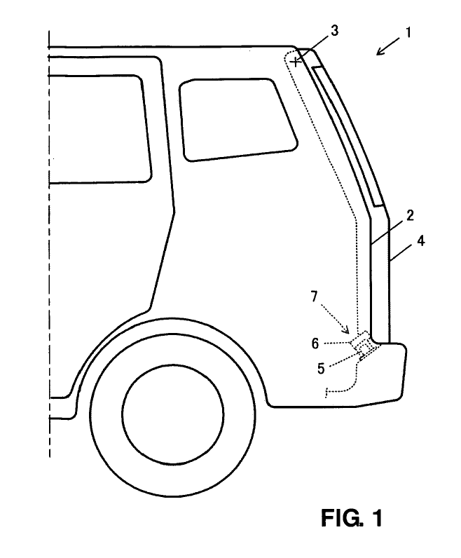

As shown in FIG. 1, an opening portion 2 for baggage loading or unloading and the like is provided at a rear portion of a vehicle 1 of the present embodiment, and the opening portion 2 is configured to be opened or closed by a lift gate 4 that is provided so as to rotate around a rotational axis 3, which is provided at an upper edge portion so as to extend in a vehicle width direction.

A striker 5 is attached to the center of a lower edge portion of the opening portion 2 in the vehicle width direction, and a latch 6 operative to engage with the striker 5 is provided at the center of a lower end portion of the lift gate 4 in the vehicle width direction. The striker 5 and the latch 6 constitute a lock device 7.

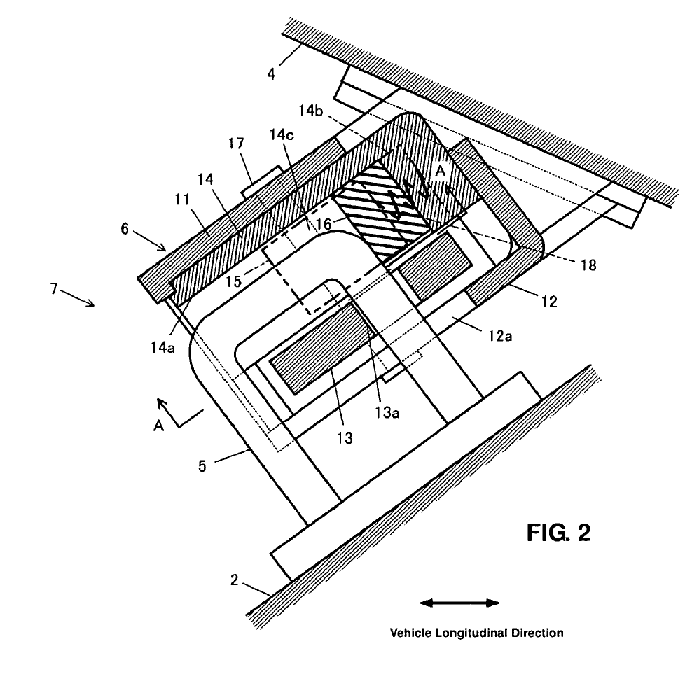

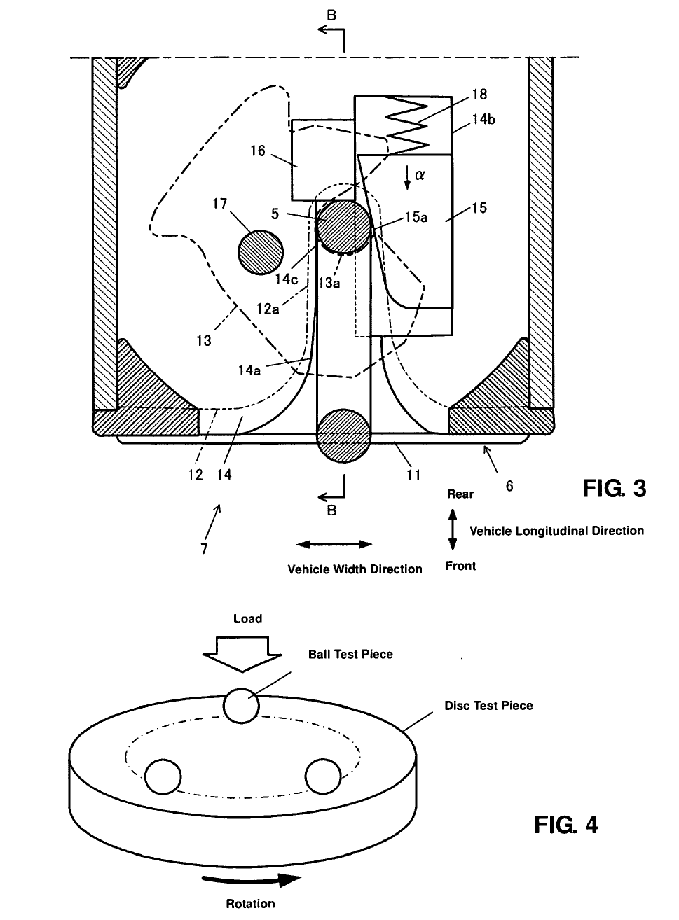

The latch 6 comprises primarily, as shown in FIGS. 2 and 3, an upper case 11 and a lower case 12, and a fork 13, a fence block 14, a slide block 15, a stop rubber 16, and a claw lever (not illustrated), which are disposed in an inner space enclosed by the cases 11, 12.

The lower case 12 has a groove portion 12a that is formed so as to extend in a vehicle longitudinal direction (an opening direction of the lift gate 4) and that is operative to receive the striker 5 coming therein.

The fork 13 is supported at a support axis 17, both end portions of which are supported at the upper and lower cases 11, 12, so as to be rotatable around the support axis 17, and it has a recess portion 13a operative to engage with the striker 5. The fork 13 is biased in an engagement release direction (a clockwise direction in FIG. 3) by a spring member, not illustrated.

The fence block 14 has a groove portion 14a that is made from polyacetal (POM) and formed so as to extend in the vehicle longitudinal direction and operative to receive the striker 5 coming therein. The width of the groove portion 14a is configured to be narrower than that of the groove portion 12a of the lower case 12.

The slide block 15 (restriction portion) is made from polyacetal (POM) and disposed in a recess portion 14b formed at one side of the groove portion 14a of the fence block 14 so as to be movable in the opening direction of the lift gate 4 (the vehicle longitudinal direction in a plan view). The slide block 15 is biased by a spring 18 in the opening direction a of the lift gate 4, and has a taper face at a side face 15a on the side of the groove portion 14a in such a manner that the distance between the side face 15a and a side face 14c of the fence block 14 becomes greater toward the vehicle rear. Thereby, as the striker 5 comes into the groove portion 14a of the fence block 14, it comes to be restricted by the side face 14c of the fence block 14 and side face 15a of the slide block 15. As a result, the lift gate 4 can be restrained from improperly shaking in the vehicle width direction (direction of the rotational axis 3) at the vehicle traveling or the like.

The stop rubber 16 functions as an impact absorbent by contacting the striker 5 of the lift gate 4 closing.

The claw lever is supported at the upper and lower cases 11, 12 so as to be rotatable, and restricts the rotation of the fork 12 in its engagement release direction (the clockwise direction in FIG. 3) at the engagement state of the fork 12 with striker 5. Herein, the claw lever is configured to be linked to an operation of a passenger via a known mechanism, which will not be described here.

According to the present embodiment, a low-friction material having lubricant function is provided at the striker 5 and/or the fence block 14 and the slide block 15 (hereinafter, the first through fifth embodiments will be described specifically). Thereby, the coefficient of friction of contact portions of these members is made small. That is, the contact portions of the striker 5 and the fence block 14 and the slide block 15 (restriction portion) are made properly slippery so as to smooth the relative movement between the lift gate 4 (closure) and the opening portion 2 of the vehicle 1 in a direction other than the direction of the rotational axis 3. As a result, the responsiveness of deformation of the vehicle body when the outer force acts on the vehicle body can be improved. Accordingly, the stability of the vehicle when traveling, for example, improves. Herein, the low-friction material may be provided not only at the contact portions of the both members but at a surrounding portion of the contact portions or at an entire part of the members.

The above-described effect can be obtained effectively in a case where the lift gate 4 (closure) opens or closes the rear opening portion 2 that may cause the deformation of the vehicle body easily when the outer force acts on. Herein, the closure of the present invention may include various types of closures, such as a side door that is provided at a passenger-ingress/egress opening portion of a vehicle side face, a lift gate that is provided at a baggage-loading/unloading opening portion of a vehicle rear face, a trunk lid that is provided at a trunk opening portion.

### Embodiment 1

The low-friction material of the first embodiment is a coating film of resin that is provided on the surface of the striker. Thereby, the anticorrosive effect can be obtained in addition to the low-friction effect. Further, the coating is superior in productivity as a method for covering the surface of the member having a shape like the striker. Herein, various types of coating method, such as spraying, electro-deposition, immersion, may be applied.

The coating film is comprised of at least one of resins of phenol, epoxy, polyamide, polyimide, polyamideimide, and tetrafluoroethylene. Thereby, the coating can be conducted easily. Herein, the best resin can be chosen depending on a specific structure of the latch structure (e.g., a contact load with the restriction portion).

Herein, the coating film may contain a lubricant material. Thereby, the coefficient of friction between the striker and the restriction portion is made much lower, so the above-described effect can be further improved.

The volume ratio of the lubricant material relative to the coating film may be preferably 1 through 50%. Thereby, the low-friction effect and the wear resistance of the coating film can be made compatible. A too-low volume ratio of the lubricant material may cause an insufficient low-friction effect. Meanwhile, the more that ratio increases, the more the low-friction effect improves. However, over 50% of the volume ratio, the improvement of the low-friction effect may not change substantially, but the wear resistance may decrease and become short instead.

The thickness of the coating film may be preferably 1 through 300 μm. Thereby, the wear resistance and the economical efficiency of the coating film can be made compatible. A too-thin thickness of the coating film may cause an insufficient resistance because of a prompt wear. Meanwhile, the more the thickness increases, the more the resistance improves. However, over the thickness of 300 μm, the resistance may become excessive, which may not be economical. Herein, the thickness of the coating film may be more preferably 3 through 100 μm. Thereby, the wear resistance and the economical efficiency of the coating film can be made compatible properly.

The surface roughness of the coating film may be preferably less than Ra 5.0 μm. Thereby, any scratching or the like of the restriction portion can be prevented. A too-rough surface may scratch another member improperly. Herein, the surface roughness can be adjusted by a later-applied treatment. Herein, the surface roughness of the coating film may be more preferably less than Ra 2.5 μm. Thereby, any scratching or the like of the restriction portion can be prevented properly.

In a case where the striker is made from steel, an anticorrosive treatment may be preferably applied to a base of the coating film. Thereby, the proper anticorrosive effect can be obtained, thereby improving the corrosion resistance. Various types of anticorrosive treatments, such as zincification, transformation, metal-piece dispersion treatment into a silicon-based inorganic binder, may be applied.

### Embodiment 2

The low-friction material of the second embodiment is comprised of at least one of nickel and chromium and a plating layer that contains a lubricant material that is comprised of at least one of molybdenum bisulfide, tungsten bisulfide, graphite, boron nitride, tetrafluoroethylene, and silicone resin. Thereby, the coefficient of friction with the contacting member can be made low. Further, the superior resistance can be expected more, compared to the rein coating film. The best low-friction material can be chosen depending on the specific structure of the latch structure (e.g., a contact load with the contacting member). Further, applying a nickel or chromium based plating to the entire surface of the striker can provide the anticorrosive effect in addition to the low-friction effect.

The volume ratio of the lubricant material relative to the plating layer may be preferably 1 through 50%. Thereby, the low-friction effect and the wear resistance of the plating layer can be made compatible. A too-low volume ratio of the lubricant material may cause an insufficient low-friction effect. Meanwhile, the more that ratio increases, the more the low-friction effect improves. However, over 50% of the volume ratio, the improvement of the low-friction effect may not change substantially, but the wear resistance may decrease and become short instead.

The thickness of the plating layer may be preferably 0.1 through 200 μm. Thereby, the wear resistance and the economical efficiency of the plating layer can be made compatible. A too-thin thickness of the plating layer may cause an insufficient resistance because of a prompt wear. Meanwhile, as the thickness increases, the resistance may improve. However, over the thickness of 200 μm, the resistance may become excessive, which may not be economical. Herein, the thickness of the plating layer may be more preferably 1 through 50 μm. Thereby, the wear resistance and the economical efficiency of the plating layer can be made compatible properly.

The surface roughness of the plating layer may be preferably less than Ra 2.0 μm. Thereby, any scratching or the like of the restriction portion can be prevented. A too-rough surface may scratch another member improperly. Herein, the surface roughness can be adjusted by a later-applied treatment. Herein, the surface roughness of the plating layer may be more preferably less than Ra 0.5 μm. Thereby, any scratching or the like of the restriction portion can be prevented properly.

### Embodiment 3

The low-friction material of the third embodiment is provided by at least one of manners of deposition, thermal spraying, film adhesion, and tube-inserting. Herein, the best method can be chosen depending on the specific structure of the latch structure (e.g., the contact load with the contacting member).

### Embodiment 4

The low-friction material containing a lubricant material of the fourth embodiment is provided on the surfaces of the fence block 14 and the slide block 15 (restriction portion) of the latch 6. Thereby, the coefficient of friction between the striker 5 and the restriction portion can be made low. Herein, the coating film of the first embodiment and the film adhesion of the third embodiment may be used as the low-friction material.

### Embodiment 5

The lubricant material of the fifth embodiment as the low-friction material is contained in a base material (base material of the restriction portion) of the fence block 14 and the slide block 15 of the latch 6. Thereby, the coefficient of friction between the striker 5 and the restriction portion can be made much lower. For example, the base material is made from polyacetal and the low-friction material is comprised of at least one of silicone resin, molybdenum bisulfide, tungsten bisulfide, graphite, boron nitride, tetrafluoroethylene, and lubricating oil. Thereby, the mechanical properties and the proper low friction of the restriction portion can be provided.

### Embodiment 6

The base material of the fence block 14 and the slide block 15 (restriction portion) of the latch 6 of the sixth embodiment is made from a micro-crystal type POM (polyacetal) that has the low-friction effect. Thereby, the coefficient of friction can be made less than 0.1 (friction-lowering means), so that the same effect as the low-friction material provided is obtained.

Test Sample

The coefficient of friction between the striker 5 and the fence block 14 and slide block 15 was tested based on the following method. Herein, values of the coefficient of friction were obtained through a ball-on-disc test that using test pieces, not real products.

The test method will be described. As shown in FIG. 4, ball test pieces (samples) were made from the striker's material, and a disc test piece (sample) was made from the material of the restriction portion (the fence block 14 and the slide block 15). Each ball test piece comprises a steel ball having the diameter of 5/16 in. and the surface roughness of Ra 0.05 μm or less, and a low-friction material provided on the surface of the steel ball.

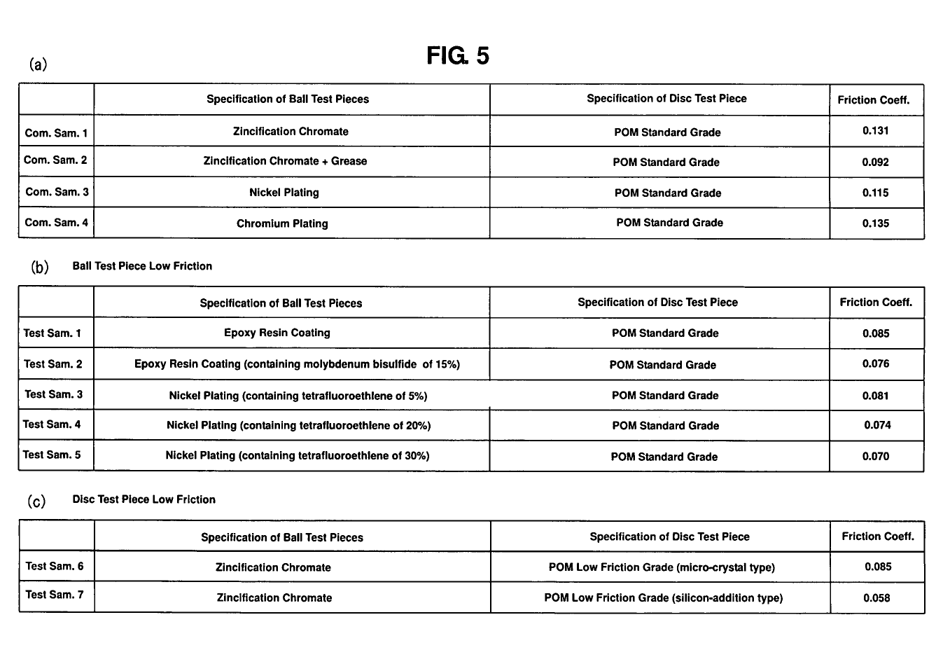

Three ball test pieces were fixed, without rotating, on an identical circumference with the diameter of 44 mm with constant intervals on the disc piece, and they were pressed against the disc test piece with the load of 100 N in total. Then, the disc test piece was rotated for one minute so that a slippery speed between the ball test pieces and the disc test piece can be 100 m/s. Here, the coefficient of friction was measured, and the average value of the coefficient of friction from during a test term was obtained. This friction test was conduced in an atmosphere of the temperature of 25° C. and the humidity of 40%. The test results are shown in FIG. 5.

At first, comparative samples will be described. In a comparative sample 1, the ball test pieces of the steel ball with zincification c provided thereon and the disc test piece made from POM (standard grade) resin were used. In this case, the coefficient of friction was 0.131, which was greater than 0.1. Herein, the POM (standard grade) means the one that does not contain any lubricant material and has its coefficient of friction relative to the zincification chromate is 0.1 or more.

In a comparative sample 2, the ball test pieces of the steel ball with zincification chromate and grease provided thereon and the disc test piece made from POM (standard grade) resin were used. In this case, the coefficient of friction was 0.092, which was less than 0.1. However, there are problems in that the surface is improperly sticky and some maintenance for anti-drying will be necessary due to drying or the like.

In a comparative sample 3, the ball test pieces of the steel ball with nickel plating (normal one without any lubricant material) provided thereon and the disc test piece made from POM (standard grade) resin were used. In this case, the coefficient of friction was 0.115, which was greater than 0.1.

In a comparative sample 4, the ball test pieces of the steel ball with chromium plating (normal one without any lubricant material) provided thereon and the disc test piece made from POM (standard grade) resin were used. In this case, the coefficient of friction was 0.135, which was greater than 0.1.

Accordingly, the coefficient of friction of the comparative samples 1 (zincification chromate), 3 (nickel plating) and 4 (chromium plating), other than the comparative sample 2 with grease, was greater than 0.1. Herein, those samples with the coefficient of friction of 0.1 or less are considered to be the low friction.

Next, test samples will be described. Test samples 1-5 were samples in which the low-friction materials were provided on the ball test piece (striker's material).

In a test sample 1 (corresponding to the first embodiment), the ball test pieces of the steel ball with epoxy resin, as the low-friction material, provided thereon and the disc test piece made from POM (standard grade) resin were used. In this case, the coefficient of friction was 0.0851, which showed the low friction less than 0.1.

In a test sample 2 (corresponding to the first embodiment), the ball test pieces of the steel ball with epoxy resin containing molybdenum bisulfide of 15 volume % coated thereon, as the low-friction material, and the disc test piece made from POM (standard grade) resin were used. In this case, the coefficient of friction was 0.076, which showed the low friction which is more than the test sample 1.

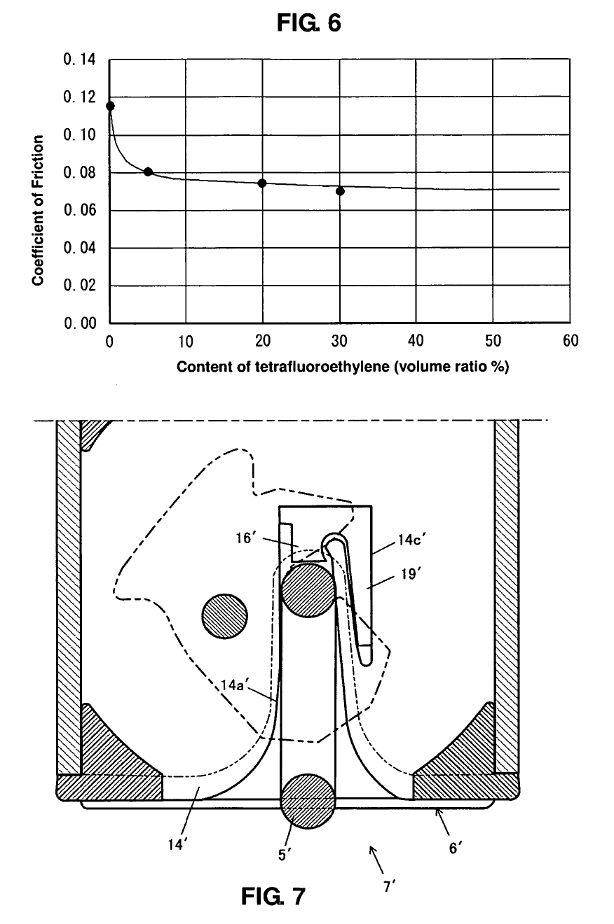

In test samples 3-5 (corresponding to the second embodiment), the ball test pieces of the steel ball with nickel plating containing tetrafluoroethylene coated thereon, as the low-friction material, and the disc test piece made from POM (standard grade) resin were used. In these cases, the coefficient of friction was 0.081 for a case of tetrafluoroethylene of 5 volume % (test sample 3), the coefficient of friction was 0.074 for a case of tetrafluoroethylene of 20 volume % (test sample 4), and the coefficient of friction was 0.070 for a case of tetrafluoroethylene of 30 volume % (test sample 5), which all showed the low friction less than 0.1. Further, as shown in FIG. 6, the coefficient of friction became lower as the volume ratio of tetrafluoroethylene became smaller. Herein, in an area where the volume ratio of tetrafluoroethylene was less than approximately 5 volume %, the coefficient of friction became lower abruptly as the volume ratio of tetrafluoroethylene became greater. In an area where the volume ratio of tetrafluoroethylene was 5 volume % or greater, the lowering rate of the coefficient of friction became smaller and there occurred substantially no change in an area above 50 volume %.

Meanwhile, test samples 6, 7 (corresponding to the fourth and fifth embodiments) are the one in which the low-friction material was provided at the disc test piece (fence block, slide block). In the test sample 6, the ball test piece of the steel ball with zincification chromate provided thereon and the disc test piece made from POM (low friction grade (micro-crystal type)) resin were used. In this case, the coefficient of friction was 0.085, which showed the low friction less than 0.1.

In the test sample 7 (corresponding to the sixth embodiment), the ball test piece of the steel ball with zincification chromate provided thereon and the disc test piece made from POM (low friction grade (silicon-addition type) resin were used. In this case, the coefficient of friction was 0.058, which showed the much lower friction less than 0.1.

Modification

Although the above-described embodiments show the example in which the slide block 15 is provided at the latch 6, the present invention can be applied to the lock device without the slide block. In a latch 6′ of another modified lock device 7′ shown in FIG. 7, at one side of a groove portion 14a′ of a fence block 14′ is formed a groove portion 14c′ that extends in substantially the same direction as the groove portion 14a′. Further, an extending portion 19′ that is formed integrally with a stop rubber 16′ is provided so as to engage with the groove portion 14c′, and a striker 5′ is restricted by both-side faces of the groove portion 14a′ of the fence block 14′ with a resilient force of the extending portion 19′. In this case, the above-described various means for the low friction can be applied to the striker 5′ and the fence block 14′, so that the same function and effects can be provided as well.

Although the above-described embodiments show the examples in which the low-friction treatment is applied either the striker or the restriction portion, the low-friction treatment may be applied to the both. In this case the low-friction effect can be obtained more effectively.

Also, there may be provided any types of smoothing means for smoothing the movement of the closure in a specified direction, including the above-described embodiments. According to the soothing means, the striker and the restriction portion can be made slippery in the direction other than the restriction direction, so that the above-described effects can be provided.

What is claimed is:

1. A lock device of a closure for a vehicle, comprising:
a striker;
a latch to engage with the striker, the latch including a restriction portion operative to restrict a movement of a closure in a direction of a rotational axis of the closure by contacting the striker,
wherein a low-friction material having lubricant function is provided at a contact portion of at least one of the striker and the restriction portion.

2. The lock device of a closure for a vehicle of claim 1, wherein the closure is a member that is provided so as to open and close a rear opening of the vehicle.

3. The lock device of a closure for a vehicle of claim 1, wherein the low-friction material is a coating film of resin that is provided on a surface of the striker.

4. The lock device of a closure for a vehicle of claim 3, wherein the coating film is comprised of at least one of resins of phenol, epoxy, polyamide, polyimide, polyamideimide, and tetrafluoroethylene.

5. The lock device of a closure for a vehicle of claim 3, wherein the coating film contains a lubricant material that is comprised of at least one of molybdenum bisulfide, tungsten bisulfide, graphite, boron nitride, tetrafluoroethylene, and silicone resin.

6. The lock device of a closure for a vehicle of claim 5, wherein the volume ratio of the lubricant material relative to the coating film is 1 through 50%.

7. The lock device of a closure for a vehicle of claim 3, wherein the thickness of the coating film is 1 through 300 μm.

8. The lock device of a closure for a vehicle of claim 3, wherein the thickness of the coating film is 3 through 100 μm.

9. The lock device of a closure for a vehicle of claim 7, wherein a surface roughness of the coating film is less than Ra 5.0 μm.

10. The lock device of a closure for a vehicle of claim 7, wherein a surface roughness of the coating film is less than Ra 2.5 μm.

11. The lock device of a closure for a vehicle of claim 3, wherein the striker is made from steel, and an anticorrosive treatment is applied to a base of the coating film.

12. The lock device of a closure for a vehicle of claim 1, wherein the low-friction material is comprised of at least one of nickel and chromium and a plating layer that contains a lubricant material that is comprised of at least one of molybdenum bisulfide, tungsten bisulfide, graphite, boron nitride, tetrafluoroethylene, and silicone resin.

13. The lock device of a closure for a vehicle of claim 12, wherein the volume ratio of the lubricant material relative to the plating layer is 1 through 50%.

14. The lock device of a closure for a vehicle of claim 12, wherein the thickness of the plating layer is 0.1 through 200 μm.

15. The lock device of a closure for a vehicle of claim 12, wherein the thickness of the plating layer is 1 through 50 μm.

16. The lock device of a closure for a vehicle of claim 14, wherein a surface roughness of the plating layer is less than Ra 2.0 μm.

17. The lock device of a closure for a vehicle of claim 14, wherein a surface roughness of the plating layer is less than Ra 0.5 μm.

18. The lock device of a closure for a vehicle of claim 1, wherein the low-friction material is provided by at least one of manners of deposition, thermal spraying, film adhesion, and tube-inserting.

19. The lock device of a closure for a vehicle of claim 1, wherein a lubricant material as the low-friction material is provided on a surface of a base material of the restriction portion of the latch.

20. The lock device of a closure for a vehicle of claim 1, wherein a lubricant material as the low-friction material is contained in a base material of the restriction portion of the latch.

21. The lock device of a closure for a vehicle of claim 20, wherein a base material of the restriction portion of the latch is made from polyacetal, and the low-friction material is comprised of at least one of silicone resin, molybdenum bisulfide, tungsten bisulfide, graphite, boron nitride, tetrafluoroethylene, and lubricating oil.

22. A lock device of a closure for a vehicle, comprising:
a striker;
a latch to engage with the striker, the latch including a restriction portion operative to restrict the striker; and
a friction-lowering means for reducing the coefficient of friction between the striker and the restriction portion of the latch less than 0.1.

23. A lock device of a closure for a vehicle, comprising:
a striker;
a latch to engage with the striker, the latch including a restriction portion operative to restrict a movement of a closure in a direction of a rotational axis of the closure by contacting the striker; and
a smoothing means for smoothing a movement of the striker in a direction other than the direction of the rotational axis of the closure.
